(19) United States
(12) Patent Application Publication
(10) Pub. No.: US 2007/0119960 A1
(43) Pub. Date: May 31, 2007

(54) Thermostat with USB hub function

(76) Inventor: Bo ZHENG, Hong Kong (HK)

Correspondence Address: Eric Chan, 42 Pin Oaks Drive, Phoenixville, PA, 19460, US

(21) Appl. No.: 11/468,373

(22) Filed: Aug. 30, 2006

(30) Foreign Application Priority Data
Nov. 28, 2005 (HK) 05110835.3

(51) Int. Cl. G05D 23/00

(52) U.S. Cl. 236/1 R

(57) ABSTRACT

The present invention relates to a thermostat with USB hub function, which can be connected to a computer USB port and which comprises one uplink USB port (1) and a plurality of downlink USB ports (2) with a hub chip (3) disposed in between, and further comprises an electrothermal component (4) which contacts the metal plate (8) on the surface of the casing of the thermostat with USB hub function, and the electrothermal component is connected to the power terminal (32) of the uplink USB port (1) which corresponds to the computer USB port, characterized in that it comprises an integrated temperature measuring module and a liquid crystal display (6), which are interconnected with each other, and the integrated temperature measuring module comprises a temperature sensor R29 (41) which contacts the metal plate, and the liquid crystal display is disposed on the surface of the casing. The thermostat displays the current time and the temperature of the metal plate by means of the temperature sensor and the liquid crystal display with the time unit of the integrated temperature measuring module, thereby allowing users to make their own choices according to the information as shown.

### BACKGROUND OF THE INVENTION

The present invention relates to computer peripheral devices and more particularly pertains to a thermostat with USB hub function.

USB hubs can increase the number of USB ports of computers and are widely used by consumers. As a small piece of domestic electrical appliance, a thermostat keeps the warmth of an object (such as milk or coffee in a cup or glass) placed thereon by means of a metal plate and thus provides users' convenience. The applicant of the present invention has filed with the Patent Office of China an earlier patent application for the invention “A thermostat with USB hub port”, which can integrate the two functions into one to provide convenience to users. However, when using such a product, the user does not know the information such as the current temperature of the metal plate and the current time.

### BRIEF SUMMARY OF THE INVENTION

The technical problem to be resolved by the present invention is how to provide a thermostat with USB hub function, which can display directly the information of the temperature of the metal plate and the current time.

In view of the aforesaid disadvantages now present in the prior art, the present invention provides a thermostat with USB hub function, which can be connected to a computer USB port and which comprises one uplink USB port and a plurality of downlink USB ports with a hub chip disposed in between, and further comprises an electrothermal component which contacts the metal plate on the surface of the casing of the thermostat with USB hub function, and the electrothermal component is connected to the power terminal of the uplink USB port which corresponds to the computer USB port, characterized in that it comprises an integrated temperature measuring module and a liquid crystal display, which are interconnected with each other, and the integrated temperature measuring module comprises a temperature sensor which contacts the metal plate, and the liquid crystal display is disposed on the surface of the casing.

In the thermostat with USB hub function provided according to the present invention, the uplink USB port connects to the computer USB port by means of a fixed cable.

In the thermostat with USB hub function provided according to the present invention, the uplink USB port connects to the computer USB port by means of the input port on the casing and the cable corresponding to the input port.

In the thermostat with USB hub function provided according to the present invention, the input port is a standard USB port and the corresponding cable is a standard USB cable.

In the thermostat with USB hub function provided according to the present invention, the input port can be of any form or structure, but comprises a power terminal, an earth terminal, a data receiving terminal and a data transmitting terminal, and the cable comprises a power supply cable, an earth cable and two data cables corresponding to the power terminal, the earth terminal, the data receiving terminal and the data transmitting terminal.

The thermostat with USB hub function provided according to the present invention further comprises an external direct current power source, and the thermostat with USB hub function connects to the external direct current power source by means of the power supply port and the power supply cable.

In the thermostat with USB hub function provided according to the present invention, the external direct current power source directly connects to the plurality of downlink USB ports, the hub chip and the electrothermal component by means of the power supply port and the power supply cable, and the uplink USB port power terminal indirectly connects to the plurality of downlink USB ports, the hub chip and the electrothermal component by means of diodes. When the thermostat with USB hub function is connected to the external direct current power source, it automatically uses the external direct current power.

In the thermostat with USB hub function provided according to the present invention, the power terminals of the integrated temperature measuring module and the liquid crystal display connect to the power terminal of the uplink USB port.

In the thermostat with USB hub function provided according to the present invention, the power terminals of the integrated temperature measuring module and the liquid crystal display connect to the installed self-contained battery.

In the thermostat with USB hub function provided according to the present invention, the power terminals of the integrated temperature measuring module and the liquid crystal display connect to the power terminal of the uplink USB port and the installed self-contained battery by means of a power switch which indicates the ON/OFF status.

In the thermostat with USB hub function provided according to the present invention, the liquid crystal display is disposed with a backlight.

In the thermostat with USB hub function provided according to the present invention, the power terminal of the backlight connects to the power terminal of the uplink USB port.

In accordance with the present invention which provides a thermostat with USB hub function, the power terminal of the backlight connects to the installed self-contained battery.

In accordance with the present invention which provides a thermostat with USB hub function, the power terminal of the backlight connects to the power terminal of the uplink USB port and the installed self-contained battery by means of the power switch of the backlight.

In accordance with the present invention which provides a thermostat with USB hub function, the integrated temperature measuring module also has a built-in timing unit which comprises a timer and a temperature measuring module, and the liquid crystal display is one or more, which displays or separately display information such as the current time and the temperature of the metal plate.

The present invention provides a thermostat with USB hub function which displays the current temperature of the metal plate by means of the temperature sensor and the liquid crystal display. It further displays the current time by means of a time unit. Users can know clearly the current time and the temperature of the metal plate, and are able to make their own choices accordingly.

### BRIEF DESCRIPTION OF THE DRAWINGS

FIG. 1 is the schematic diagram of the thermostat with USB hub function of the present invention.

FIG. 2 is the block diagram of the circuit of the thermostat with USB hub function as shown in FIG. 1.

FIG. 3 is the schematic diagram of the circuit of the main body of the thermostat with USB hub function as shown in FIG. 2.

FIG. 4 is the schematic diagram of the circuit of the liquid crystal display module of the thermostat with USB hub function as shown in FIG. 2.

FIG. 5 is the schematic diagram of the circuit of the backlight of the liquid crystal display module as shown in FIG. 4 powered by the computer USB port power source.

FIG. 6 is the schematic diagram of the circuit of the backlight of the liquid crystal display module as shown in FIG. 4 powered by battery power.

FIG. 7 is the schematic diagram of the circuit of the backlight of the liquid crystal display module as shown in FIG. 4 which is selectively powered by the computer USB port power source or by battery power.

FIG. 8 is the schematic diagram of the circuit of the liquid crystal display of the liquid crystal display module as shown in FIG. 4 powered by the computer USB port power source.

FIG. 9 is the schematic diagram of the circuit of the liquid crystal display of the liquid crystal display module as shown in FIG. 4 powered by battery power.

FIG. 10 is the schematic diagram of the circuit of the liquid crystal display of the liquid crystal display module as shown in FIG. 4 which is selectively powered by the computer USB port power source or by battery power.

### DETAILED DESCRIPTION OF THE INVENTION

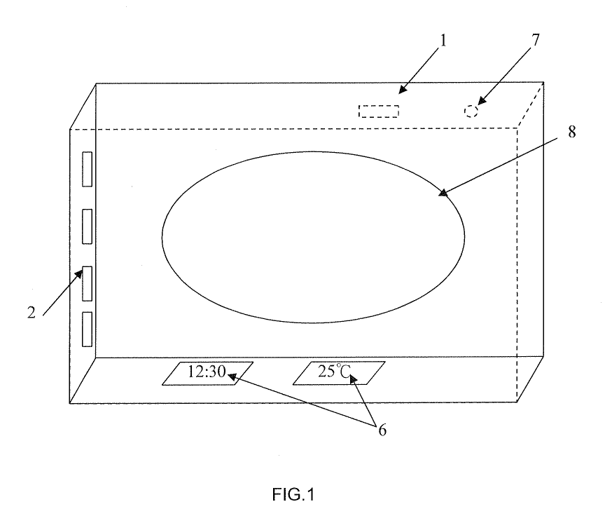

As illustrated in FIG. 1, the thermostat with USB hub function of the present invention is in rectangular shape but not limited to rectangular shape. The part facing users comprises two liquid crystal displays 6 which show the current time and the temperature of the metal plate respectively. On the top of it, there is a disc-shaped metal plate 8. There are four downlink USB ports 2 on one side and one uplink USB port 1 at the back which connects to a computer USB port by means of a USB cable. There is also a direct current power supply port 7 which connects to an external direct current power source and this can be used when there is insufficient power supply from the computer USB port.

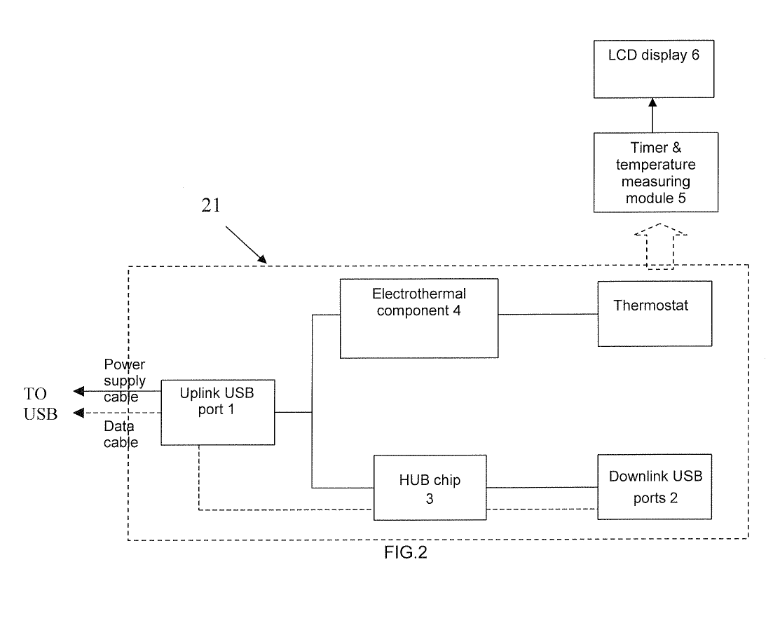

As illustrated in FIG. 2, the thermostat with USB hub function of the present invention comprises the main body 21 and the supplementary liquid crystal display module (comprising the timer, the temperature measuring module and the liquid crystal display). The main body 21 comprises an uplink USB port 1, downlink USB ports 2, a hub chip 3 and an electrothermal component 4. The electrothermal component 4 is powered by the computer USB port power source. A standard USB port comprises a power supply cable (as shown in solid line) and a data cable (as shown in broken line). The electrothermal component 4 only connects to the power supply cable (as shown in solid line). The thermostat is formed by the disc-shaped metal plate 8.

As illustrated in FIG. 3, in the circuit of the main body of the thermostat with USB hub function of the present invention, the uplink USB port comprises a VCCI power terminal 32, an earth GND terminal 33 and DM & DP data terminals. The electrothermal component 4 comprises parallel resistors R20, R21, R22 and R34, which connect to the VCCI power terminal 32 of the uplink USB port 1 by means of the switch SW1. By means of the combined diodes 31 comprising diodes D1 and D2, power is supplied to the device (comprising the downlink USB ports 2 and the hub chip 3). Alternatively, by means of the direct current power supply port 7, it can connect to the external direct current power source.

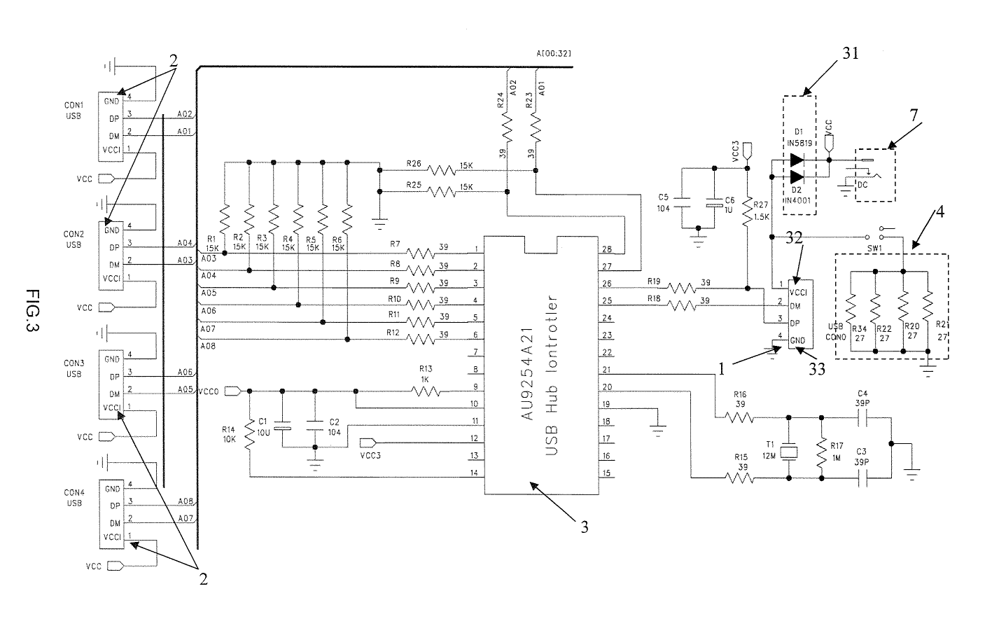

As illustrated in FIG. 4, the circuit of the supplementary liquid crystal display module of the thermostat with USB hub function of the present invention uses the integrated circuit AST2331 and the temperature sensor R29 to realize measuring and displaying of the temperature of the metal plate. Meanwhile, the integrated circuit AST2331 has timing function to display the current time by means of changing the display mode SW5, setting the time SW4, adjusting upwards SW6, adjusting downwards SW3, restoring the chip SW2 and counting the time by a crystal oscillator T2. The backlight 9 is a LED light. A switch can be installed to control it.

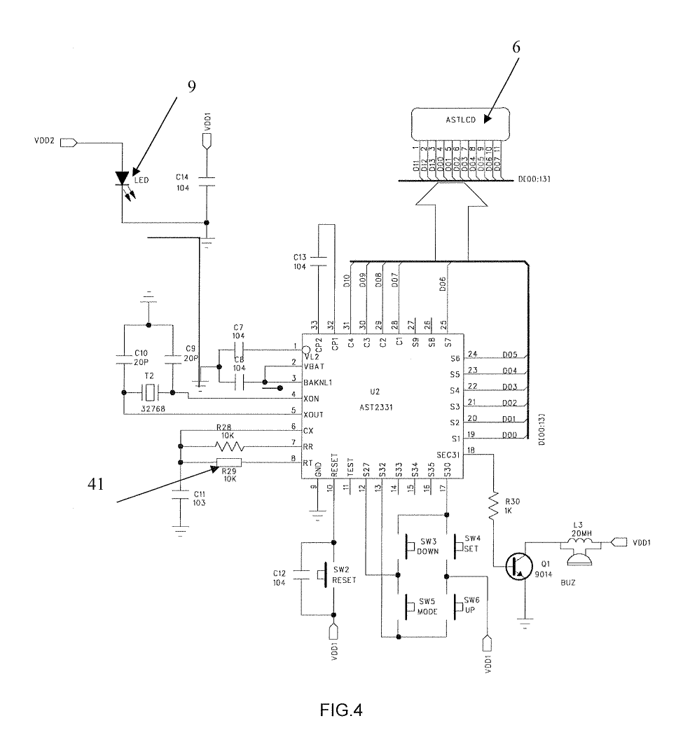

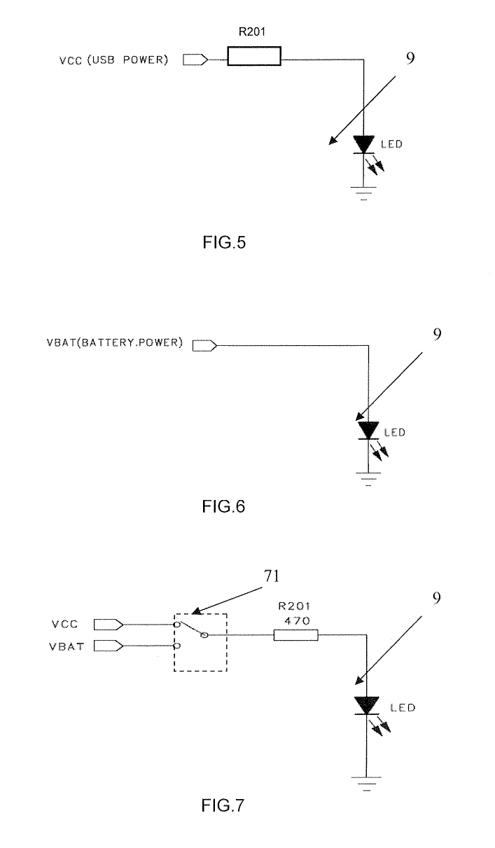

As illustrated in FIGS. 5, 6 and 7, the backlight 9 can be powered in three ways, namely, power from the computer USB port, power from battery or power from both the computer USB port and the battery by means of connecting the same through the power switch 71 of the backlight.

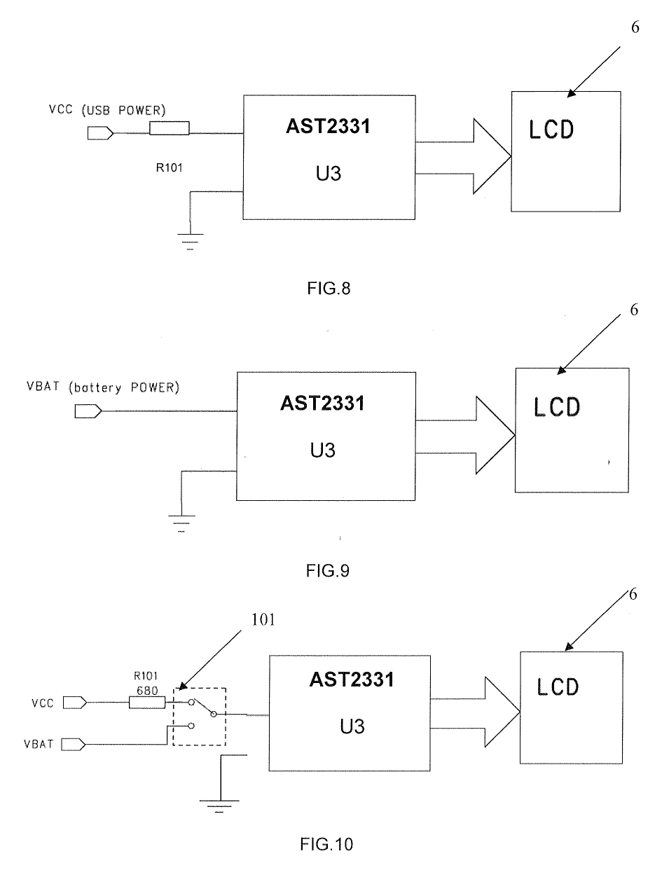

As illustrated in FIGS. 8, 9 and 10, the temperature measuring module 5 and the liquid crystal displays 6 can also be powered in three ways, namely, power from the computer USB port, power from battery or power from both the computer USB port and the battery by means of connecting the same through the power switch 71 of the backlight.

The above are only the preferred embodiments of the present invention. Any equivalents and modifications according to the scope of the claims of the present invention fall within the scope of the present invention.

What is claimed is:

1. A thermostat with USB hub function, which can be connected to a computer USB port and which comprises one uplink USB port (1) and a plurality of downlink USB ports (2) with a hub chip (3) disposed in between, and further comprises an electrothermal component (4) which contacts the metal plate (8) on the surface of the casing of the thermostat with USB hub function, and the electrothermal component is connected to the power terminal (32) of the uplink USB port (1) which corresponds to the computer USB port, characterized in that it comprises an integrated temperature measuring module and a liquid crystal display (6), which are interconnected with each other, and the integrated temperature measuring module comprises a temperature sensor R29 (41) which contacts the metal plate, and the liquid crystal display is disposed on the surface of the casing.

2. The thermostat with USB hub function as in claim 1, characterized in that the uplink USB port (1) directly connects to the computer USB port by means of a fixed cable.

3. The thermostat with USB hub function as in claim 1, characterized in that the uplink USB port (1) connects to the computer USB port by means of the input port on the casing and the cable corresponding to the input port.

4. The thermostat with USB hub function as in claim 3, characterized in that the input port is a standard USB port and the corresponding cable is a standard USB cable.

5. The thermostat with USB hub function as in claim 3 or 4, characterized in that the input port comprises a power terminal (32), an earth terminal (33), a data receiving terminal and a data transmitting terminal; and the cable comprises a power supply cable, an earth cable and two data cables corresponding to the power terminal, the earth terminal, the data receiving terminal and the data transmitting terminal.

6. The thermostat with USB hub function as in claim 1, characterized in that it further comprises an external direct current power source, and the thermostat with USB hub function connects to the external direct current power source by means of the power supply port (7) and the power supply cable.

7. The thermostat with USB hub function as in claim 1 or 6, characterized in that the external direct current power source directly connects to the plurality of downlink USB ports, the hub chip and the electrothermal component by means of the power supply port (7), and the uplink USB port power terminal indirectly connects to the plurality of downlink USB ports, the hub chip and the electrothermal component by means of diodes (31).

8. The thermostat with USB hub function as in claim 1, characterized in that the power terminals of the integrated temperature measuring module and the liquid crystal display (6) connect to the power terminal of the uplink USB port.

9. The thermostat with USB hub function as in claim 1, characterized in that the power terminals of the integrated temperature measuring module and the power terminal of the LCD monitor (6) connect with the battery the power terminals of the integrated temperature measuring module and the liquid crystal display (6) connect to the battery.

10. The thermostat with USB hub function as in claim 1, characterized in that the power terminals of the integrated temperature measuring module and the liquid crystal display (6) connect to the power terminal of the uplink USB port and the battery by means of a power switch (101) which indicates the ON/OFF status.

11. The thermostat with USB hub function as in claim 1, characterized in that the liquid crystal display (6) is disposed with a backlight (9).

12. The thermostat with USB hub function as in claim 1 or 10, characterized in that the power terminal of the backlight (9) connects to the power terminal (31) of the uplink USB port.

13. The thermostat with USB hub function as in claim 1 or 10, characterized in that the power terminal of the backlight (9) connects to the battery.

14. The thermostat with USB hub function as in claim 1 or 10, characterized in that the power terminal of the backlight (9) connects to the power terminal (31) of the uplink USB port and the battery by means of the power switch (71) of the backlight.

15. The thermostat with USB hub function as in claim 1, 8, 9 or 10, characterized in that the integrated temperature measuring module also has a built-in timing unit which comprises a timer and a temperature measuring module (5), and the liquid crystal display (6) is one or more.
